(19) United States
(12) Patent Application Publication
(10) Pub. No.: US 2014/0075795 A1
(43) Pub. Date: Mar. 20, 2014

(54) Dual Core High Density Polyethylene Outdoor Advertising Furniture

(71) Applicant: Permanent Impressions, LLC, Isle of Palms, SC (US)

(72) Inventor: Stephen Carrier, Mount Pleasant, SC (US)

(73) Assignee: Permanent Impressions, LLC, Isle of Palms, SC (US)

(21) Appl. No.: 14/028,463

(22) Filed: Sep. 16, 2013

Related U.S. Application Data
(60) Provisional application No. 61/702,414, filed on Sep. 18, 2012.

(51) Int. Cl. G09F 7/00; A47C 1/14

(52) U.S. Cl. CPC G09F 7/002; A47C 1/14
USPC 40/584; 29/428

(57) ABSTRACT

Constructing and advertising on outdoor furniture using a plurality of layers of durable and resistant dual core high-density polyethylene (HDPE) material and colorful three-dimensional engraved advertising imagery.

### CROSS-REFERENCE TO RELATED APPLICATIONS

U.S. Provisional Application No. 61/702,414

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The present invention relates to outdoor furniture and advertising.

### BACKGROUND OF THE INVENTION

Outdoor furniture has been constructed from materials, such as wood, nylon, aluminum, and composite plastics, and coated with paints, stains, and other treatments. There is a long felt commercial need for outdoor furniture that is durable and resistant to deterioration.

Advertising imagery is generally displayed on billboards, signs, and print and electronic media. There is a long felt commercial need for advertising displays that are highly visible to and garner attention from potential consumers of the advertiser's goods and services.

High-density polyethylene (HDPE) is a commonly used material for a wide variety of products, including plastic bags, bottle caps, hard hats, boat hulls, and water pipes. HDPE is known for its high strength to density ratio and resistance to solvents and deterioration and a wide range of temperatures.

### BRIEF SUMMARY OF THE INVENTION

The present invention relates to durable outdoor advertising furniture. The invention involves a plurality of colored layers of HDPE material, referred to herein as dual core HDPE material, whereby three-dimensional advertising imagery is engraved in the layers, and the engraved dual core HDPE material is then cut into segments and assembled into outdoor furniture, resulting in outdoor furniture that incorporates highly visible multi-colored three-dimensional advertising imagery that is durable and resistant to the conditions to which outdoor furniture is subjected, including the stress of human body weight, scratching and wear and tear, insects, mold, salt, cleaning chemicals, ultraviolet sunrays, and the entire range of extreme weather conditions experienced on earth. The invention further involves the choosing of the number and dimensions of the layers, the use of computer controlled engraving machinery, and the use of ultraviolet inhibitors, color concentrates, resins, assembly by removable and replaceable segments, and other features described in further detail below.

### BRIEF DESCRIPTION OF THE SEVERAL VIEWS OF THE DRAWING

FIG. 1 shows a perspective view of assembled outdoor furniture incorporating advertisement imagery according to the present invention.

FIG. 2 shows a perspective side view of a sheet of dual core HDPE material with a first colored layer and a second colored layer according to the present invention.

FIG. 3 shows an elevation view of engraved three-dimensional advertising imagery in the said first colored layer of the said sheet of dual core HDPE material to expose the said second colored layer according to the present invention.

FIG. 4 shows an elevation view of a sheet of dual core HDPE material cut into segments that contain parts of the said three-dimensional advertising imagery according to the present invention.

### DETAILED DESCRIPTION OF THE INVENTION

There are many possible embodiments of the invention, some of which are described below.

For illustrative purposes, one embodiment of the present invention is described and represented in the drawings with respect to an outdoor chair. It should be understood by those having skill in the art that all varieties of outdoor furniture incorporating advertising imagery may be constructed according to the present invention.

In one embodiment, the sheet of dual core HDPE material to be provided in the present invention may have the following properties: Density: 59.6 lbs/ft³; Melt Index, Condition 190° C./2.16 kg: Polyethylene Classification: Grade 2, Class 3, Grade 5; Tensile Strength @ Yield: 4000 psi; Ultimate Elongation: >600%; Tensile Impact Strength: 70 ft-lbf/in²; Notched Izod Impact Strength: 299 ft-lfb/in; Compressive Stress @ Yield: 1,500 psi; ESCR, Condition A (10% lgepal) F₅₀: 45 hours; ESCR, Condition B (10% lgepal) F₅₀: 35 hours; Durometer Hardness: 64 Shore D; Flexural Modulus: 200,000 psi; Coefficient of Friction, Static: 0.31; Coefficient of Friction, Kinetic: 0.22; Coefficient of Linear Thermal Expansion: 7×10⁻⁵ in/in/° F.; Decomposition Temperature: ˜650° F.; Vicat Softening Temperature: 257° F.; Heat Deflection Temperature @66 psi: 171° F.; Brittleness Temperature: <−120° F.; Glass Transition Temperature: −193° F.; Continuous Use Temperature: −100° F. to 180° F.; Thermal Conductivity: 2.5 Btu-in/h-ft²-° F.; Burn Rate: 1 in/min; Ignition Temperature, Flash Conditions: 645° F.; Ignition Temperature, Self Ignition Conditions: 660° F.; Flame Spread: 98; Smoke Developed: 350; Fire Rating: UL94HB; Dielectric Strength: 510 V/mil; Dielectric Constant: 2.35; Volume Resistivity: 2.3×10¹⁵ ohm-in. It should be understood by those having skill in the art that dual core HDPE material having similar properties may be substituted for this preferred HDPE material and used in the method of the present invention.

In one embodiment, the sheet of HDPE dual core material to be provided in the present invention may be prepared by: blending pellets of HDPE and color concentrate in a blender at a ratio of 97 percent HDPE with 2 percent color and 1 percent ultraviolet inhibitor additive; this color mixture is fed into a hopper on an extruder; when multiple colors are being used, the blended mixture will be fed into two separate machines; one machine will extrude the top and bottom color and the second machine will extrude the middle color; the extruder heats and mixes the pellets into a honey like consistency; this material is then pushed through a die that will take the material and spread it out to be approximately 56 inches wide; this now flat extrusion is fed through three cooling rolls that set the gauge of the sheet and start the cooling process; the texture is then embossed on the now smooth sheet by reheating the surface and pressing emboss rolls with the required pattern onto the sheet; the material then travels down a long set of conveyor rollers which cools the sheet to room temperature and sets the material for cutting; the sheet is cut to length and width. It should be understood by those having skill in the art that dual core HDPE material prepared according to other processes may also be used in the present invention.

In one embodiment, the sheet of HDPE dual core material to be provided in the present invention may include more than two colored layers, such that advertising imagery may be engraved into multiple layers at the necessary depths to expose multiple additional colors.

In one embodiment, a third color or multiple additional colors may be added by filling parts of the engraved advertising imagery with resin of a third or multiple additional colors.

In one embodiment, the resin to be provided in the present invention may be comprised of a two part modified epoxy resin that can be mixed with colors and ultraviolet inhibitors.

In one embodiment, the resin to be provided in the present invention may be comprised of ISOPROPYLIDENEDIPHENOL EPICHLOROHYDRIN POLYMER having the following properties: Boiling Point: >200° C.; Vapor Pressure: <1 MMGH; Vapor Density: >1 AIR=1; Evaporation Rate: N/A; Solubility in Water: NEGLIG; Specific Gravity: 1.16-1.18 Water=1; Percent Volatile: NEGLIG; Volatile Organic Compounds: N/A; VOC Less H2O & Exempt Solvents: N/A; PH: N/A; Viscosity: >120 Poises; Melting Point: N/A; Appearance and Odor: Very Light, yellow liquid; and PHENOL, 4-NONYL-, BRANCHED N-AMINOETHYLPIPERAZINE POLYOXYALKYLENEAMINE having the following properties: Boiling Point: >390° F.; Vapor Pressure: 2 MMHG; Vapor Density: >1 AIR=1; Evaporation Rate: <1 BUDAC=1; Solubility in Water: SLIGHT; Specific Gravity: 0.95-0.99 Water=1; Percent Volatile: NEGLIG; Volatile Organic Compounds: N/A; VOC Less H2O & Exempt Solvents: N/A; PH: N/A; Viscosity: <600 CPS; Melting Point: N/A; Appearance and Odor: Amber, liquid, ammonia odor. It should be understood by those having skill in the art that the resin to be provided in this embodiment of the present invention may also be comprised of different chemical components and have different properties that accomplish the same function of providing additional colors to the advertising imagery.

In one embodiment, the total thickness of a sheet of dual core HDPE material that is provided in the present invention can be chosen by one having ordinary skill in the art according to the strength requirements of the particular type of outdoor furniture to which it is applied.

In one embodiment, the top layer of the sheet of dual core HDPE material having a first color is one eighth of an inch thick; the middle layer having a second color is one half of an inch thick; and the bottom layer matching the first color is one eighth of an inch thick, whereby the dual core HDPE material may be engraved on both the top and bottom to expose matching color combinations. These preferred dimensions strike a balance between providing the structural strength necessary to support human body weight, particularly when the top and bottom layers are engraved upon; minimizing the discomfort caused when the engraved advertising imagery is pressed upon a human body; ensuring that scratches on the surface of the top and bottom layers that may occur from standard wear and tear to outdoor furniture do not expose the differently colored middle layer; and enhancing the three-dimensional effect of the advertising imagery. Furthermore, this preferred embodiment is advantageous because the advertising imagery engraved on the top may match or, alternatively, be different from the advertising imagery on the bottom, which allows the outdoor furniture to accommodate repetitive advertising imagery on the top and bottom or differentiated advertising imagery on the top and bottom.

In one embodiment of the invention, the dual core HDPE material may be used for only certain components of the outdoor furniture that are preferred locations for the advertising imagery, such as the back of a chair or the top of a stool, while the remainder of the furniture is constructed from mono-colored HDPE material or other less expensive materials.

In one embodiment of the invention, the advertising imagery may be located on detachable and replaceable components of the outdoor furniture, such as the back of a chair or the top of a stool. The advantage of this embodiment allows the advertiser to modify its advertising imagery seasonally or otherwise according to its business needs, as opposed to having to produce a completely new piece of outdoor furniture.

Advertising imagery includes any commercial or noncommercial pictures, designs, words, slogans, and logos.

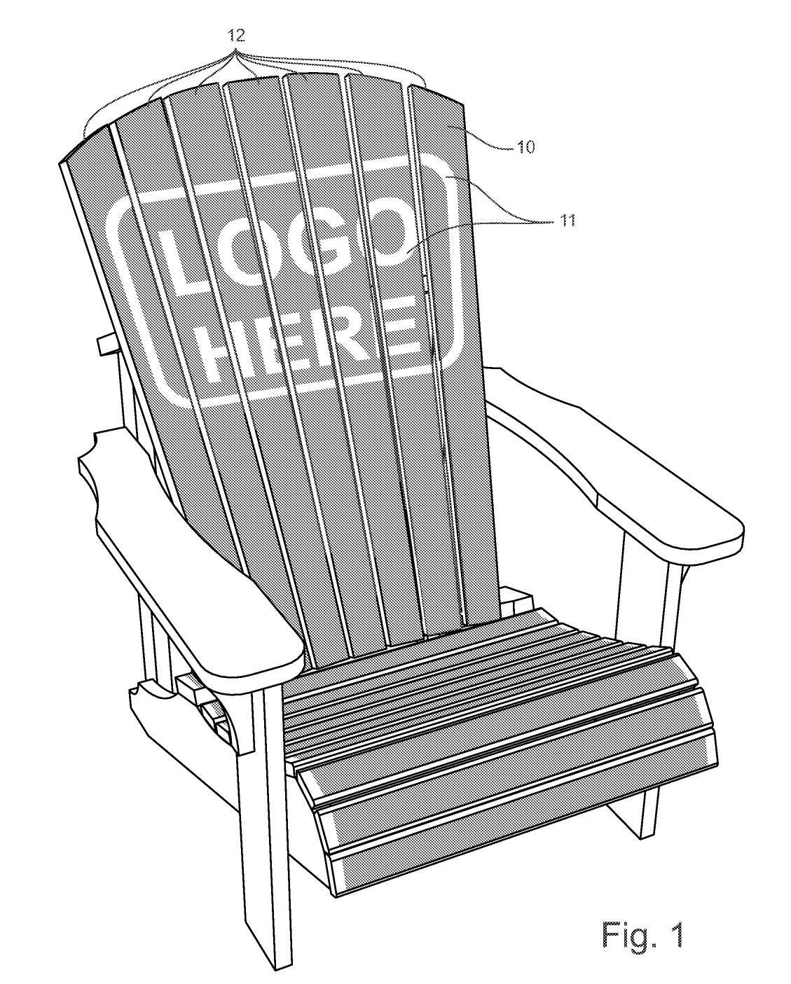

In further detail, FIG. 1 shows a fully assembled outdoor chair with advertising imagery constructed out of segments 12 of dual core HDPE material according to the method of the present invention, with a first colored layer 10, and a second colored layer 11.

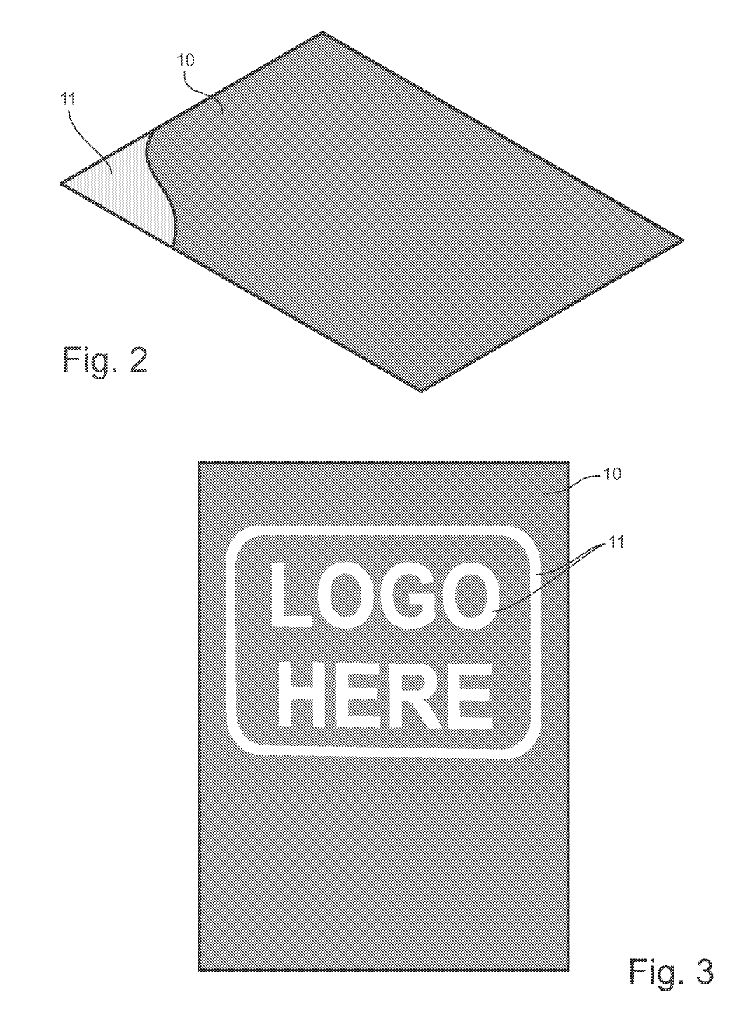

In further detail, FIG. 2 shows the step of the present invention of providing a sheet of dual core HDPE material with a first colored layer 10 and a second colored layer 11.

In further detail, FIG. 3 shows the step of the present invention of engraving advertisement imagery in the first colored layer 10 of the sheet of dual core material to a depth necessary to expose the second colored layer 11.

Engraving the dual core material may be done with hand tools, electric tools including a drill and routing bit, or preferably by a computer operated machine that can engrave digital images, which those having skill in the art sometimes refer to as computer numerical control (CNC) machines, which use computer-aided-design (CAD) and computer-aided manufacturing (CAM) programs to control the engraving operation.

During the engraving step, each layer of dual core HDPE material is preferably engraved only to the depth necessary to fully expose the layer below.

In one embodiment, the edge of the engraved advertising imagery is beveled at an angle. One preferred beveled angle is 60 degrees, although other angles less than 90 degrees may also be used according to the present invention. The advantages of beveling the outline of the engraved advertising imagery include: minimizing the discomfort caused when the engraved advertising imagery is pressed upon a human body compared with a 90 degree ledge; reducing the effects of wear and tear on the outline of the engraved advertising compared with a 90 degree ledge; and enhancing the three-dimensional effect of the advertising imagery compared with a 90 degree ledge.

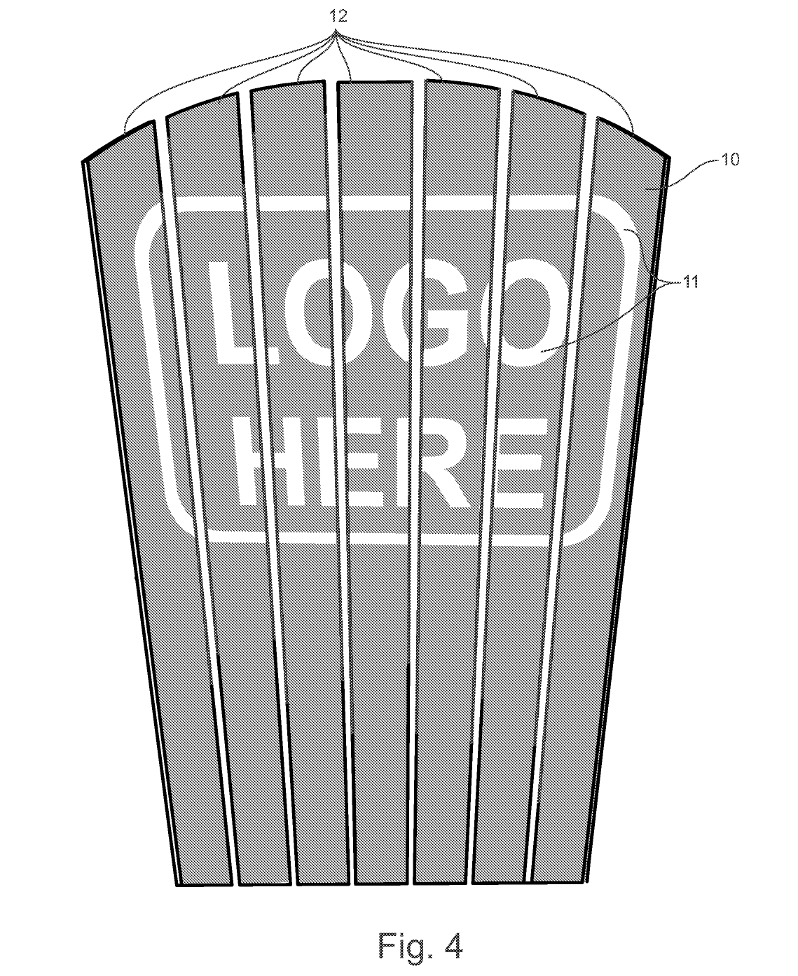

In further detail, FIG. 4 shows one embodiment of the present invention whereby the sheet of HDPE dual core material engraved with advertising imagery is cut into segments 12 that contain parts of the advertisement imagery engraved in the first colored layer 10 of the sheet of dual core material to a depth necessary to expose the second colored layer 11. The segments are then assembled as shown in FIG. 1.

Alternatively, in another embodiment of the present invention, the sheet of HDPE dual core material engraved with advertising imagery is cut into the shape of one contiguous component of outdoor furniture, such as the back of a chair, such that the component is one contiguous piece of HDPE dual core material that does not require further assembly or supporting structure, except as to its attachment to the rest of the outdoor furniture. The advantage to this embodiment is that by removing the need for supporting structure, more space is available for advertising imagery on both the front and back of the component of outdoor furniture, such as the back of a chair.

Cutting the dual core material may be done with all cutting means known by those having skill in the art, such as a saw, knife, or blade.

Assembling the furniture may be done by all assembly means known by those having skill in the art, such as with screws, bolts, glues, and joints.

Further advantages of the present invention include resulting outdoor furniture that incorporates advertising imagery that is equally durable to the outdoor furniture on which it is displayed, such that the outdoor furniture together with the advertising imagery can withstand stress of human body weight, scratching and wear and tear, and have the same resistance mold, salt, cleaning chemicals, ultraviolet sunrays, and the entire range of extreme weather conditions experienced on earth, and any minimal deterioration will occur uniformly so as to preserve the cohesive appearance of the outdoor furniture together with its advertising imagery. Further advantages include resulting advertising imagery that is highly visible for advertising purposes because the engraving process produces a three-dimensional image, which is more perceptible than a one-dimensional image to the human eye, and because the dual core HDPE material may be comprised of various combinations of vibrant colors that draw the attention of the human eye.

While the foregoing written description of the invention enables one of ordinary skill to make and use what is considered presently to be the best mode thereof, those of ordinary skill will understand and appreciate the existence of variations, combinations, and equivalents of these specific embodiments. The invention should therefore not be limited by the above described embodiments, but shall include all embodiments within the scope and spirit of the invention.

1. What is claimed is a method of constructing durable outdoor furniture incorporating three-dimensional advertising imagery comprising the steps of:
i. providing a sheet of HDPE material with a plurality of colored layers;
ii. engraving advertising imagery on the top side of the sheet of HDPE material to depths necessary to expose one or more colored layers beneath the top colored layer;
iii. cutting the said sheet of HDPE material with advertising imagery into segments of outdoor furniture;
iv. assembling the said segments of outdoor furniture into outdoor furniture.

2. The method of claim 1 where the sheet of HDPE material with a plurality of colored layers includes ultraviolet inhibitors.

3. The method of claim 1 with the additional step of engraving advertising imagery on the bottom side of the sheet of HDPE material to a depth necessary to expose one or more colored layers above the bottom colored layer.

4. The method of claim 1 where the HDPE material has three layers, a top colored layer, a middle colored layer, and a bottom colored layer.

5. The method of claim 1 where the HDPE material has three layers, a top colored layer, a middle colored layer, and a bottom colored layer, and the additional step is taken of engraving advertisement imagery on the bottom side of the sheet of HDPE material to a depth necessary to expose the middle colored layer.

6. The method of claim 1 where the HDPE material has three layers, a top colored layer, a middle colored layer, and a bottom colored layer, and the depth of the top colored layer is one eighth of an inch, the depth of the middle colored layer is one half of an inch, and the depth of the bottom colored layer is one eighth of an inch, and the additional step is taken of engraving advertisement imagery on the bottom side of the sheet of HDPE material to a depth necessary to expose the middle colored layer.

7. The method of claim 1 whereby one or more additional colors are added to the said advertising imagery by filling part of the said engraved advertising imagery with a resin of one or more additional colors and a mixture of ultraviolet inhibitors.

8. The method of claim 1 whereby the engraving step is performed by a computer operated machine using digital advertising imagery.

9. The method of claim 1 where the engraving step is performed by beveling the edge of the engraved advertising imagery at an angle less than 90 degrees.

10. The method of claim 1 whereby the said segments of outdoor furniture are independently removable and replaceable as to the outdoor furniture as a whole so that new segments containing different advertising imagery may be substituted.

11. The method of claim 1 where the sheet of HDPE material includes ultraviolet inhibitors and has three layers, a top colored layer, a middle colored layer, and a bottom colored layer, and the depth of the top colored layer is one eighth of an inch, the depth of the middle colored layer is one half of an inch, and the depth of the bottom colored layer is one eighth of an inch, and the additional step is taken of engraving advertisement imagery on the bottom side of the sheet of the HDPE material to a depth necessary to expose the middle colored layer, and the engraving steps are performed by a computer operated machine using digital advertising imagery and the engraving step includes beveling the edge of the engraved advertising imagery at an angle less than 90 degrees.

12. What is claimed is a method of advertising comprising the steps of:
i. providing a sheet of HDPE material with a plurality of colored layers;
ii. engraving advertising imagery on the top side of the sheet of the HDPE material to depths necessary to expose one or more colored layers beneath the top colored layer;
iii. cutting the said sheet of HDPE material with advertising imagery into segments of outdoor furniture;
iv. assembling the said segments of outdoor furniture into outdoor furniture;
v. placing the outdoor furniture incorporating the advertising imagery in locations where potential consumers of the advertised goods and services will physically use the outdoor furniture and view the advertising imagery thereon.

13. The method of claim 12 where the sheet of HDPE material with a plurality of colored layers includes ultraviolet inhibitors.

14. The method of claim 12 with the additional step of engraving advertising imagery on the bottom side of the sheet of HDPE material to a depth necessary to expose one or more colored layers above the bottom colored layer.

15. The method of claim 12 where the HDPE material has three layers, a top colored layer, a middle colored layer, and a bottom colored layer.

16. The method of claim 12 where the HDPE material has three layers, a top colored layer, a middle colored layer, and a bottom colored layer, and the additional step is taken of engraving advertising imagery on the bottom side of the sheet of HDPE material to a depth necessary to expose the middle colored layer.

17. The method of claim 12 where the HDPE material has three layers, a top colored layer, a middle colored layer, and a bottom colored layer, and the depth of the top colored layer is one eighth of an inch, the depth of the middle colored layer is one half of an inch, and the depth of the bottom colored layer is one eighth of an inch, and the additional step is taken of engraving advertisement imagery on the bottom side of the sheet of HDPE material to a depth necessary to expose the middle colored layer.

18. The method of claim 12 whereby one or more additional colors are added to the said advertising imagery by filling part of the said engraved advertising imagery with a resin of one or more additional colors and a mixture of ultraviolet inhibitors.

19. The method of claim 12 whereby the engraving step is performed by a computer operated machine using digital advertising imagery.

20. The method of claim 12 where the engraving step is performed by beveling the edge of the engraved advertising imagery at an angle less than 90 degrees.

21. The method of claim 12 whereby the said segments of outdoor furniture are independently removable and replaceable as to the outdoor furniture as a whole so that new segments containing different advertising imagery may be substituted.

22. What is claimed is outdoor furniture, comprising:
i. HDPE material with a plurality of colored layers; and
ii. advertising imagery engraved in said HDPE material.

23. The outdoor furniture of claim 22 further comprising three layers of said HDPE material, a top colored layer with a depth of one eighth of an inch, a middle colored layer with a depth of one eighth of an inch, and a bottom colored layer with a depth of one eighth of an inch.

24. The outdoor furniture of claim 22 further comprising ultraviolet inhibitors.

25. The outdoor furniture of claim 22 further comprising a beveled edge of less than 90 degrees on said advertising imagery.

26. The outdoor furniture of claim 22 further comprising removable segments of advertising imagery engraved in said HDPE material.

27. The outdoor furniture of claim 22 further comprising one or more colored resins in the said advertising imagery.

28. The outdoor furniture of claim 22 further comprising:
i. three layers of said HDPE material, a top colored layer with a depth of one eighth of an inch, a middle colored layer with a depth of one eighth of an inch, and a bottom colored layer with a depth of one eighth of an inch;
ii. ultraviolet inhibitors;
iii. a beveled edge of less than 90 degrees on along the edge of said advertising imagery; and
iv. removable segments of said advertising imagery engraved in said HDPE material; and
v. one or more colored resins in the said advertising imagery.
